(19) United States
(12) Patent Application Publication
(10) Pub. No.: US 2019/0378096 A1
(43) Pub. Date: Dec. 12, 2019

(54) Method of Providing Stability to an Asset

(71) Applicant: Donald Stanley Bielak, SR., Hockessin, DE (US)

(72) Inventor: Donald Stanley Bielak, SR., Hockessin, DE (US)

(21) Appl. No.: 16/424,564

(22) Filed: May 29, 2019

Related U.S. Application Data
(60) Provisional application No. 62/763,259, filed on Jun. 11, 2018.

(51) Int. Cl. G06Q 20/06; G06Q 40/06; G06Q 40/04

(52) U.S. Cl. CPC G06Q 20/065; G06Q 2220/00; G06Q 40/04; G06Q 40/06

(57) ABSTRACT

In one aspect, the present invention comprises a method for providing stability of price to an asset. A preferred embodiment comprises: (a) a cryptocurrency; (b) an investment account; (c) a mode of redemption; (d) a computer network; (e) a company account; (f) a cryptocurrency exchange; (g) a processing application; (h) a method of destroying a cryptocurrency; (i) a method of funding an investment account; (j) a method of investing funds in an investment account.

### FIELD OF THE INVENTION

The present invention is related to cryptocurrency; more particularly, the invention is related to providing price stability to a cryptocurrency. A cryptocurrency is a digital representation of something of value. The representation normally takes the form of a digital “coin” or “token,” which is protected by cryptography. The terms “cryptocurrency,” “token,” and “coin” are used interchangeably in this paper.

### BACKGROUND

The original cryptocurrency, Bitcoin, was designed to be a trustless, peer-to-peer electronic cash system. Unfortunately, some unforeseen problems arose from Bitcoin's use and popularity. Most notably, among these problems is price stability. It has not been uncommon for Bitcoin, among others, to experience price swings of 10%-20% in a single day.

Merchants are reluctant to accept such coins and tokens because unlike most fiat currencies, which for the most part are considered stable, cryptocurrencies that are created for use on typical blockchains can, and often do, have wild swings in price, rendering them useless for Internet commerce.

Unfortunately, the lack of price stability Bitcoin suffers from has created questions as to whether it will ever be able to serve as an everyday currency.

In some respects, Bitcoin has been a failure because, due to its instability, it cannot be used to satisfy the needs of those who hold it. In essence, it is largely useless in commerce and has become little more than a vehicle for speculation. This is not only true for Bitcoin, but also for most of the cryptocurrencies in circulation today.

Prices of tokens on the various cryptocurrency exchanges can vary widely. There have been a number of schemes to influence the price of tokens through the exchanges. This often results in unstable token prices and an unsavory environment for the investors of these cryptocurrencies.

Only a cryptocurrency which is stable can prove suitable for use as an everyday medium of exchange.

### SUMMARY

The present invention overcomes the problem of price instability experienced by Bitcoin, and others, described above. In one aspect, the present invention comprises a method for providing stability to an asset. A preferred embodiment comprises: (a) a cryptocurrency; (b) an asset account; (c) a mode of redemption; (d) a computer network; (e) a company account; (f) a currency exchange; (g) a processing application; (h) a method of destroying a cryptocurrency. (i) a method of funding an asset account.

### DETAILED DESCRIPTION OF PREFERRED EMBODIMENTS

The method of providing price stability to an asset of the preferred embodiment provides price stability to a cryptocurrency.

In order to provide stability of price, these are essentially the elements of the preferred embodiment. They are in no particular order:
1. A cryptocurrency is designed and funded.
2. A company account is established
3. An investment account is established and funded.
4. A method of investment for funds in the investment account is chosen.
5. A mode of redemption is established.
6. A processing application (app) is constructed.
7. A procedure for destroying tokens is established.
8. An exchange(s) for buying and selling the cryptocurrency is chosen.
9. A method of funding the investment account is chosen.
10. A method of determining redemption price is formulated.

In the preferred embodiment, a cryptocurrency is designed and funded. The funding may take the form of a token sale, private funding, venture capital funding, self-funding or other. For example, an initial offering may be for 10 million tokens offered for sale at 0.10 each. If all tokens from the initial offering are sold, that would yield $1 million. The proceeds of the funding is deposited in a company account.

An investment account is established and is funded by a portion of the proceeds from the funding of the cryptocurrency. The funding of the investment account can be for any amount, however for illustration purposes of the preferred embodiment, it will be 75% of a $1,000,000 funding, or $750,000.

The $750,000 is deposited into the investment account. In this example, the investment account has had a conservative investment portfolio chosen which is expected to increase the balance of the investment account.

The mode of transmission and communication is through a network, in this case the Internet.

The token is placed for trading on the open market through a choice of various cryptocurrency exchanges. The token can be placed on one or more than one exchange.

A holder of tokens can dispose of them by either selling them on the open market, selling, trading, or transferring them privately, or by redeeming them through the company.

Redemption is achieved through a company portal. The redemption price in this example is a simple mathematical equation: Amount of principal in the investment account divided by the number of tokens in circulation. A $1 million principal in the investment account with an outstanding token count of 1 million would result in a redemption price of $1 per token.

In the present invention, a redemption fee is charged. The fee is then deposited in the investment account to aid in its growth.

In this example, the redemption price will serve as a guide as to what the approximate price should be on the open market. Because holders of the tokens will be guaranteed a minimum price through redemption, the market price likely will not fall significantly below that figure. Conversely, the price on the open market should be at, or perhaps slightly above or below, the redemption price because the intrinsic value of the token is known. Wild speculation, which causes price instability, is virtually eliminated, thereby providing a stability of price necessary to a viable currency.

In the preferred embodiment, each time the token is used in commerce, a transaction fee is charged either to the party who initiates the transaction or the party who redeems it with the company in exchange for another currency or cryptocurrency. The fee is added to the investment account. This addition of fees will help the investment account to grow over time. This, too, contributes to price stability. In the present invention, this is facilitated by an application (app) which processes transactions and extracts fees.

At the end of each quarter, any profits from the investments in the investment account over and above the principal is removed and used to purchase the company's tokens either on the open market, or from an inventory of redeemed tokens. The tokens purchased are destroyed, or “burned.” The process chosen for burning tokens is fairly simple. The tokens to be destroyed are sent to an address which has a private key that is unobtainable, thereby rendering them impossible to retrieve or spend.

In another embodiment, a sovereign entity could use the present invention to provide stability to its currency. If a country had this problem, its government could promote currency stability by basically following the steps in the present invention with or without alterations which are detailed in this paper. For example, a country could establish an investment account and fund it with items of value such as precious metals, petroleum, land rights, mineral rights, foreign currencies or financial instruments, or anything or combination of things of value that could be sold and converted to a stable currency such as the USD or EUR. The value of the currency would be the convertible value of the investment account divided by the number of currency in circulation. The value of the investment account could be augmented by taxes, sales taxes, Vat taxes, proceeds from a national lottery, surcharges for various reasons, or other. The augmentation of the investment account would be optimum but is not a necessary element. Redemption would be optimum, but not necessary. Computer networks are not absolutely necessary in this example, although they could be used to some degree. In addition, an exchange would not be necessary, nor would a method of destroying the asset.

In another embodiment, a cryptocurrency could be stabilized by basically following the steps in the present invention with or without alterations detailed in this paper. For example, an investment account could be established and funded with items of value, or not funded at all. The value of the currency would be the value of the investment account divided by the number of currency in circulation. The value of the investment account could be augmented by donations, dues, fees, charges, profits, or other. The augmentation of the investment account would be optimum but is not a necessary element. Redemption would be optimum, but not necessary. Computer networks are not absolutely necessary in this example, although they could be used to some degree. In addition, an exchange would not be necessary, nor would a method of destroying the asset.

### DISCUSSION OF PRIOR ART

For much of the 19^{th} and 20^{th} centuries, the United States paper currency was backed by, and convertible for, gold. Backing the currency with the precious metal and giving bearers the ability to redeem it for gold provided a measure of stability to the currency.

In the present day, various cryptocurrencies, often referred to as “stablecoins,” or “stable tokens,” attempt to achieve stability by backing, or collateralizing, their respective currencies using one of several methods. Among these are:
1. Cryptocurrencies backed by fiat currencies such as the U.S. dollar. Cryptocurrencies such as this are “pegged” to the value of their chosen fiat currency.
2. Cryptocurrencies backed by commodities such as gold or silver. In theory, the value of the commodity imparts a tangible value to the underlying cryptocurrency. Some of these cryptocurrencies allow for conversion to the commodity, primarily those backed by a precious metal.
3. Cryptocurrencies backed by mathematical algorithms. Cryptocurrencies such as this attempt to achieve stability by utilizing a mathematical program which regulates the value of the cryptocurrency by increasing or decreasing the amount of cryptocurrency in circulation.
4. Cryptocurrencies backed by other cryptocurrencies. Cryptocurrencies such as this attempt to provide stability by maintaining a portfolio of other cryptocurrencies as collateral. In theory, the value of the portfolio would convey a tangible value to the underlying cryptocurrency.

Each of the present day cryptocurrencies which employ backing in order to achieve stability come with its particular negative feature.
1. Those cryptocurrencies backed by, or pegged to, fiat currency can provide a measure of stability but this stability comes at a cost of loss of purchasing power due to monetary inflation. One of the most desirable features that a cryptocurrency can have is the ability to serve as a store of value. In the case of fiat currency, that ability is restricted to relatively short periods of time because over longer periods of time inflation—something that is an objective of central bankers—will erode the purchasing power of the fiat currency, thereby eliminating the cryptocurrency's ability to serve as a true store of value. Therefore, the value of a cryptocurrecy backed by or pegged to a fiat currency will suffer the same loss of value as the fiat currency which backs it. In addition, this loss of value restricts both the fiat currency and those cryptocurrencies backed by it to stability only in the short term.
2. Cryptocurrencies backed by a commodity rely on the value of that commodity to remain stable enough to provide stability to its underlying cryptocurrency. The problem is that commodities are normally traded on a larger market and their prices and values can fluctuate, often significantly. For example, it is not uncommon for gold to gain or lose 5% or more in a short period of time. This fluctuation, or instability, is passed on to its underlying cryptocurrency. In addition, this uncertainty eliminates such a cryptocurrency from serving as a store of value.
3. Cryptocurrencies which employ algorithms in an attempt to provide stability are largely theoretical. The algorithms basically attempt to control the amount of cryptocurrency in circulation by either increasing or decreasing the supply depending on the edicts of the algorithmic program. As of this writing, there is no proof that such algorithms can have the desired affect of providing stability to their underlying currencies or that they will result in a cryptocurrency which can serve as a store of value. It is believed that such manipulation of the cryptocurrency is in itself a destabilizing procedure which can cause swings in value, thereby defeating its own purpose.
4. Those cryptocurrencies which are backed by a portfolio of other cryptocurrencies have not demonstrated the ability to provide stability to its underlying cryptocurrency. The vast majority of cryptocurrencies lack stability in their own right, which convey this instability when used for backing another cryptocurrency.

In an embodiment of the instant invention, stability of a cryptocurrency is achieved by collateralizing it in a novel manner. Instead of backing the cryptocurrency with any of the aforementioned methods, the cryptocurrency is backed by financial instruments in general and, in the preferred embodiment, particularly short-term, interest bearing financial instruments such as 3 month U.S. treasury bills. Backing the cryptocurrency in this manner achieves at least two important objectives with regard to stability.
1. The underlying cryptocurrency which is collateralized by financial instruments is provided stability by such collateral. Particularly, U.S. treasury bills are considered among the safest investments available and, especially in short terms such as 3 months, very stable in their own right.
2. Because Treasury bills are interest bearing, under normal circumstances the value of the collateral will increase. The objective is to increase the value of the collateral, and therefore the value of the underlying cryptocurrency, at least at the rate of inflation. This will enable the cryptocurrency to serve as a true store of value indefinitely, not simply for short periods of time such as fiat currencies or those cryptocurrencies which use fiat currency as collateral. This too, is a major contributor to stability.

1. A method for providing stability of price to an asset, comprising:
(a) providing an asset;
(b) funding said asset;
(c) establishing an investment account with said funding proceeds;
(d) investing at least a portion of said funding proceeds in a conservative investment portfolio; and
(e) placing said asset for trading on an open market.

2. The method of claim 1, wherein said asset comprises a cryptocurrency.

3. The method of claim 2, further comprising establishing a company account, and placing said funding proceeds of said initial offering into said company account.

4. The method of claim 3, further comprising providing a mode of redemption of said asset.

5. The method of claim 1, further comprising establishing a company account, and placing said funding proceeds of said initial offering into said company account.

6. The method of claim 1, further comprising providing a mode of redemption for said asset.

7. The method of claim 4, further comprising: a processing application for processing said redemption and extracting a fee.

8. The method of claim 7, further comprising a method of destroying a cryptocurrency.

9. The method of claim 8, further comprising providing a computer network for conducting transactions involving said cryptocurrency.

10. The method of claim 9, wherein said open market comprises a cryptocurrency exchange.
